(19) United States
(12) Patent Application Publication
(10) Pub. No.: US 2018/0101853 A1
(43) Pub. Date: Apr. 12, 2018

(54) Allaroundearth

(71) Applicant: Patrice Brown, Cleveland, OH (US)

(72) Inventor: Patrice Brown, Cleveland, OH (US)

(21) Appl. No.: 15/289,202

(22) Filed: Oct. 9, 2016

(51) Int. Cl. G06Q 30/02; G09B 19/00

(52) U.S. Cl. CPC G06Q 30/0201; G09B 19/00

(57) ABSTRACT

(I) Allaroundearth logo brand (E-JET & E-SPED) product Sales a (3G) pledge to a Green Global Goal Marketing Slogans allow distinguishable and recognizable branding for E-JET, & E-SPED, under umbrella Logo (Allaroundearth).” This Allaroundearth logo brand will allow pledges for a Global Environmental Agenda and create Green jobs. E-JET Green k-12 Curriculum leads to Green Job Trade Skill & Small Business upon Graduation. Green Job Training Copyright process with multi-industry Green Jobs & Small Business upon Certification of completion & On the Job Training Development. The Curriculum provides students with LEED GA, Green Training and small business skills to immediately start making an income. The Green Copyright Training invention provides an individual with a sixth grade learning level skills to obtain employment in a Green Job, Small Business and LEED GA Training, to take their skill sets and transfer them into income generating skills with or without contingency of employment from alternate outside factors and On the Job Training Development. (II) This invention will allow Outside Showering to he transportable to Construction Sites, Beaches and remote regions where potable water has limited accessibility. Green outdoor shower invention for portable use for contractors, beaches & remote regions without adequate water. (III) Wind turbine Protective Cover invention that protects birds. (VI) This Wind turbine Covering will allow standalone Wind turbines bird protection from the blades. (V) Mobile Bike Folding Exercise Rack for Bikers and Marathon Riders (VI) Mobile Folding Partition for traveling distance learning coaches and educators (VII) Synthetic-Polymer Fallopian Tube for patient pregnancy with tubal scar tissue.

### CLAIMS PRIORITY BACK PROVISIONAL APPLICATION

### Specifications

The Version of the Invention Discussed here Includes: Numeric Instructions

1. (#1) (I) ALLAROUNDEARTH LOGO BRAND

2. Attached is a (3G) Green Global Goal, pledge card, with each product sales

3. (#2) (I) E-JET GREEN K-12 EDUCATIONAL CURRICULUM

4. Green k-12 Registration

5. Green K-8, Curriculum

6. Green 9-12 Grades Individual Needs & Goals Assessment

7. Green 9-12 Grades Job Training and Workforce Development Training

8. Green 9-12 Grades Personal and Professional Development Training

9. Green 9-12 Grades Green Electives, LEED GA, Small Business Customization Training

10. Diploma, Graduation based upon State Standardize Testing

11. Mentorship Program, Internship, College Referral Program

12. (#3) (I) GREEN COPYRIGHT TRAINING PROGRAM:
a. Green, Eco-Educational, Employment and Entrepreneur Training, DVD's & Manual
b. Copyright Registration Numbers:
   i. TXu-1-774-995 Effective date of Registration May 25, 2011
   ii. TX 8-029-158 Effective date of Registration Nov. 6, 2013

13. Registration for the Green Training Program

14. Do an Individual Needs & Goals Assessment

15. Job Training and Workforce Development Training

16. Personal and Professional Development Training

17. Green Trade, LEED GA Training and Green Small Business Customization Training

18. Certification of Completion

19. Mentorship Program

20. Green Job, Internship, Temporary Labor and Permanent International Labor

21. Green Contracting, Network Marketing, Internet Marketing, Janitorial, Paint Recycling, independent Contracting, Green Residential Rehabilitation (Automated Lights and Plumbing Fixtures), Manufacturing Invention and (Nacelle-Wind turbine Supply Chain), International

22. (#4) (II) GREEN OUTDOOR SHOWERING AND DEVICE

23. (#4) (II) Portable Plastic outdoor Shelter

24.(#4) (II) Plastic expansion, funnel, water suction pump connected to water or Rain barrel

25. Plastic Pedal pump connected to plastic funnel connection inside Rain Barrel to suction up water to Showerhead in Portable Plastic outdoor Shelter

26. (#5) (III) WINDTURBINE PROTECTIVE COVERING

27. (#5) (III) Large to Medium Size WIND TURBINES: Plastic or Steel Wings, with ½′ to 1″ V-Shaped. Horizontal & Vertical, Square & Rectangular openings

28. (#5) (III) Connected to Each Blade based upon Length×Width×Depth

29. Plastic or Steel Clamp Connections to Each Blade

30. (#5) (III) Small WIND TURBINES Plastic or Steel Wings, with ½′ to 1″ V-Shaped, Horizontal & Vertical, Square & Rectangular openings

31. (#5) (III) Connected together based upon Length×Width×Depth of Blades

32. (#5) (III) Plastic or Steel Clamp Connections together to Each Wind turbine Protective Covering

33. (#6) (I) E-JET SLOGAN: “Healthy Learning=Healthy Living”, E-SPED SLOGAN: “Eco-Savings is Our Business”

34. (#7) (IV) MOBILE BIKE EXERCISE—FOLDING RACK for Bikers and Marathon Riders

35. (#7) (IV) Folding Hinges made of Plastic with Plastic or Metal Handles

36. (#8) (V) MOBILE FOLDING PARTITION for traveling distance learning coaches and educators

37. (#8) (V) Folding Hinges made of Plastic with Plastic or Metal Handles and Pockets for Files

38. (#9) (VI) SYNTHETIC—POLYMER FALLOPIAN TUBE for patient pregnancy with tubal scar tissue

39. (#9) (VI) Artificial or transplant, attach to Uterus and Ovaries

### Relationship Between the Components:

Steps (1&2) Allaroundearth will have the logo marketing brand for (E-JET. Inc & E-SPED organizations) product sales, Steps (3-11) the F-JET Green k-12, Curriculum, (12-21) the Green copyright (also Curriculum for On the Job) Green Training Program. Steps (22-25) The Green Outdoor Shower and Steps (26-32) the Wind turbine Protective Covering. Step (33) E-JET Inc & E-SPED distinguishable, Slogans, under umbrella brand marketing of Allaroundearth, Steps (1&2). Steps (6-9) are duplicated in the E-JET Green, k-12 Curriculum in Steps (14-17) Green Copyright Training Program for Adults and the Youth Summer Program, also as on the job training. Steps (10-11) and (20-21) are based upon the level of Academics, Green Program Registration or On the Job Training. Steps (22-25) are Related to the GREEN OUTSIDE SHOWER INVENTION. Steps (26-32) Are Related to the WINDTURBINE PROTECTIVE COVERING INVENTION. Step (33) E-JET Slogan is related to Steps (3-20) E-JET, Green, k-12 Curriculum and Green Copyright Curriculum (Adult and Youth Summer Program) & E-SPED Slogans are related to Steps (12-21) The Green Copyright Curriculum for on the job training development. Steps (34-35) MOBILE BIKE EXERCISE—FOLDING RACK for Bikers and Marathon Riders with Folding Hinges made of Plastic with Plastic or Metal Handles. Steps (36-37) MOBILE FOLDING PARTITION for traveling distance learning coaches and educators with Folding Hinges made of Plastic with Plastic or Metal Handles and Pockets for Files. Steps (38-39) SYNTHETIC—POLYMER FALLOPIAN TUBE for patient pregnancy with tubal scar tissue an Artificial or transplant, attach to Uterus and Ovaries.

How the Invention Works:

Steps (1&2) are a marketing logo brand that raise awareness to a Green Global Goal, create products, promote and bring a global awareness to Steps (3-33). Steps (3-11) E-JET Green k-12 Curriculum will allow students a job, career of college preparation in the Green Industry. Steps (12-21) Green Copyright Program will allow Client both the preparation for a Green Job and Small business in the Green Industry, and On the Job Training Development. Steps (22-25) Green Outdoor Shower will allow for jobs, product sales, health safety practices through having greater accessibility to showers. Steps (26-32) Wind turbine Protective Covering product sales, will lower barriers to entry into the market, protect the birds, and create jobs. Step (33) E-JET & E-SPED Slogans will create recognizable, distinguishable, goal and objectives. Steps (1&2) are a marketing logo brand for Steps (3-33). Steps (10-11) are based upon the successful completion of Steps (3-9). Steps (20-21) are based upon the successful completion of steps (12-19). Steps (22-25) are Based upon the connection to an outdoor Privacy portable Showering Shelter (Like porta-potty) and connection to water barrel (Like Rainbarrel). Steps (26-32) Will require Plastic or Steel Manufacturing of Wind turbine Protective Coverings. (33) Will distinguish each business marketed under umbrella logo of Steps (1&2). Steps (34-35) MOBILE BIKE EXERCISE—FOLDING RACK for Bikers and Marathon Riders with Folding Hinges made of Plastic with Plastic or Metal Handles, Steps (36 -37) MOBILE FOLDING PARTITION for traveling distance learning coaches and educators with Folding Hinges made of Plastic with Plastic or Metal Handles and Pockets for Files. Steps (38-39) SYNTHETIC—POLYMER FALLOPIAN TUBE for patient pregnancy with tubal scar tissue an Artificial or transplant, attach to Uterus and Ovaries.

How to Make the Invention:

Steps (1&2) Allaroundearth pledge brand & marketing Logo placed on products and merchandise for sale. Steps (3-21) E-JET Green k-12 Accredited Curriculum & Green Copyright Training program will become licensed, for use and Contracting. Steps (22-32) prototype will be made through a Prototype Company, College or University; final products will be made through Manufacturing Plant. Steps (33) Will be placed on T-Shirts, active wear or Uniforms. Steps (1, 3-10, 12-19 & 21) are necessary elements for training and Human Capital. Steps (22-32) are necessary elements for job creation. Steps (2, 11 and 20) are Optional elements. The elements to make product better is Human Capital, Sales Marketing Team and employment for those in specified fields. Steps (6-11) are elements that are interchangeable with Steps (14-20). Steps (10 & 18) are reconfigured based upon Age and Academic enrollment status. Steps (33) Both business organizations has its own Slogan for recognizable, distinguishable, and branding under umbrella marketing logo. Steps (34-35) MOBILE BIKE EXERCISE—FOLDING RACK for Bikers and Marathon Riders with Folding Hinges made of Plastic with Plastic or Metal Handles. Steps (36 -37) MOBILE FOLDING PARTITION for traveling distance learning coaches and educators with Folding Hinges made of Plastic with Plastic or Metal Handles and Pockets for Files. Steps (38-39) SYNTHETIC—POLYMER FALLOPIAN TUBE for patient pregnancy with tubal scar tissue an Artificial or transplant, attach to Uterus and Ovaries.

How to Use the Invention:

(I) Allaroundearth, marketing brand logo (E-JET & F-SPED) product purchase with (3G) Pledge to help raise Green Global Goals, (2) E-JET Green k-12 Curriculum, a person can purchase a contract to facilitate in their Academic Environments (i.e. Schools) (3) Green Copyright Training, a person can purchase a contract to facilitate training in their organization, Academic Environment or Business (ie. Non-profits, Colleges or Universities, Business Organizations). (4) Green Outdoor Shower, a person can purchase the Merchandise or product and locate on a Construction Site, Beach or remote regions to make a healthy environmental impact. (5) Wind turbine Protective Cover, a person can purchase an order for Customized Coverings based upon size, of Wind turbine and Blade Length. (6) Slogans can only be used on the Products of E-JET or E-SPED. Additionally: Steps (1-21) E-JET. Green k-12 and Green Copyright Training can be done through technology and online. Steps (22-33) products, purchasing orders can be done through technology and online. Also, it can create: Steps (1&2) Allaroundearth brand logo can produce T-Shirts, School and office products, in addition to marketing of additional products. Steps (22-32) Green Outdoor Shower (Plastic Shower Connection & Shelter) and Wind turbine Protective Covering are both products that can be produced. Step (33) Slogans can be produced on E-Jet & E-SPED Products. Steps (34-35) MOBILE BIKE EXERCISE—FOLDING RACK for Bikers and Marathon Riders with Folding Hinges made of Plastic with Plastic or Metal Handles. Steps (36-37) MOBILE FOLDING PARTITION for traveling distance learning coaches and educators with Folding Hinges made of Plastic with Plastic or Metal Handles and Pockets for Files. Steps (38-39) SYNTHETIC—POLYMER FALLOPIAN TUBE for patient pregnancy with tubal scar tissue an Artificial or transplant, attach to Uterus and Ovaries.

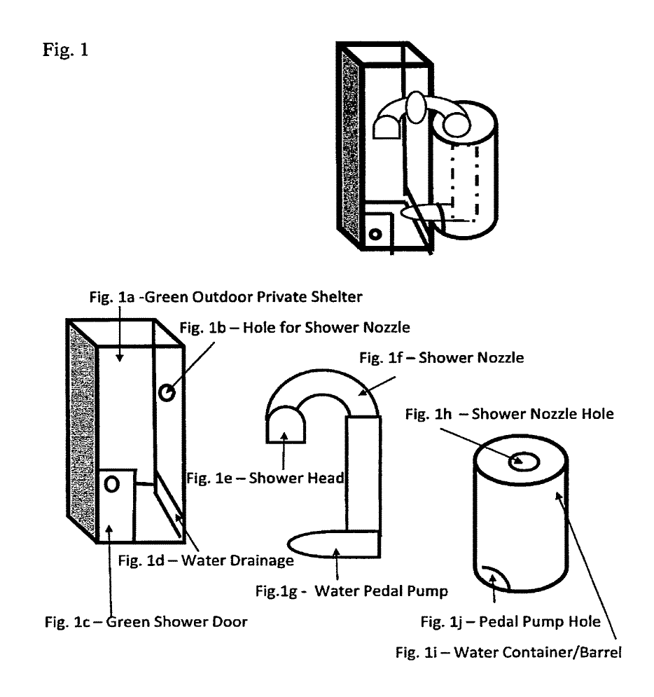

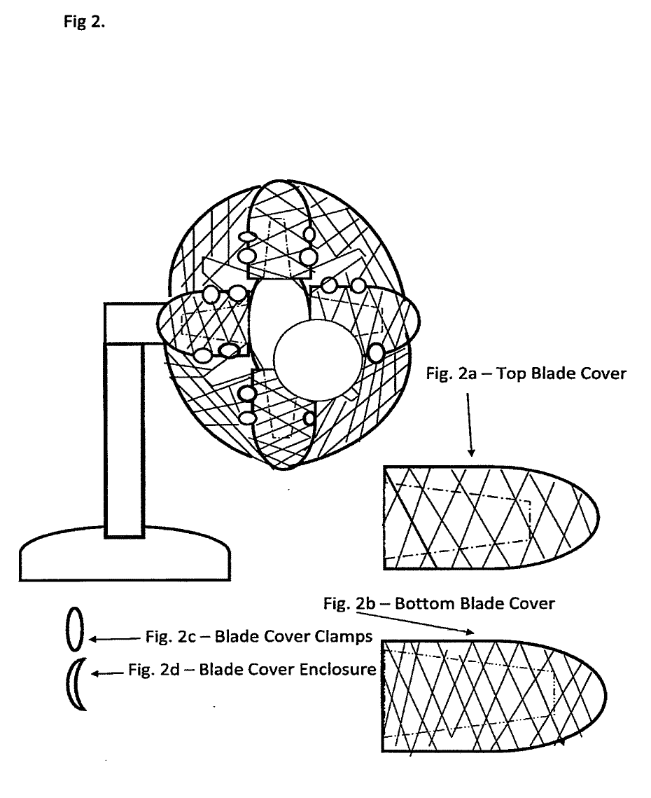

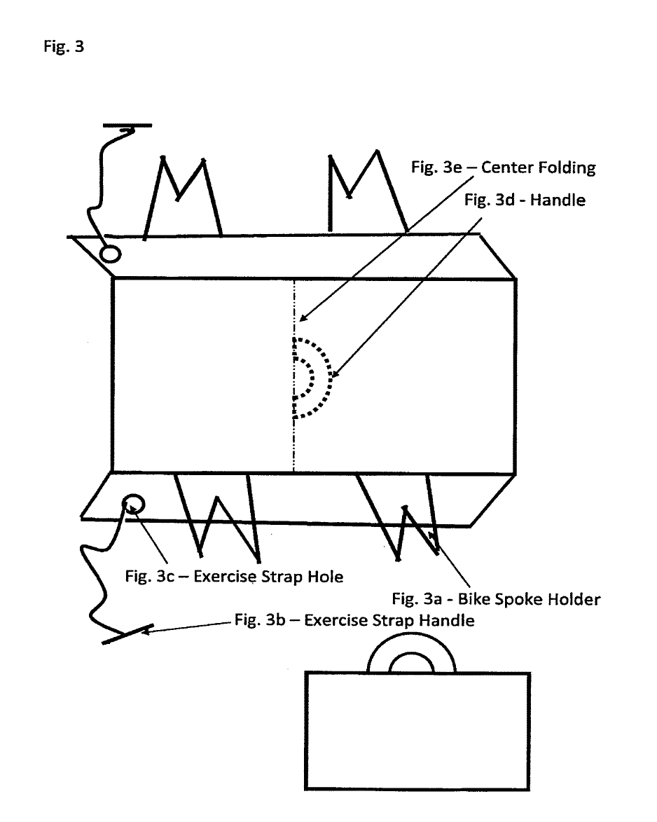

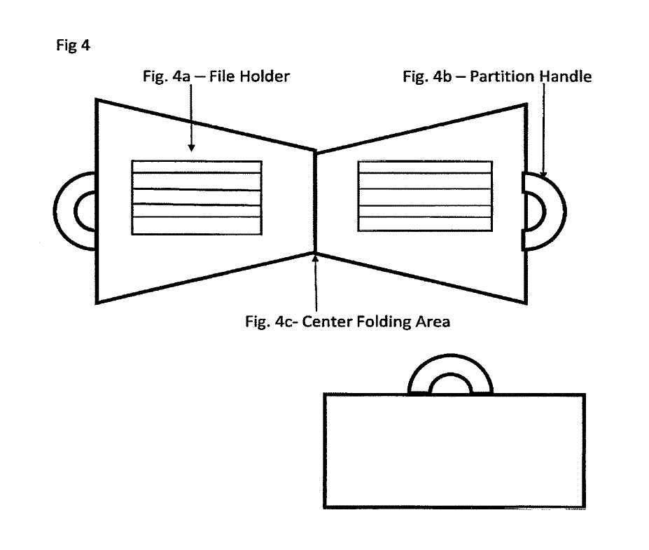

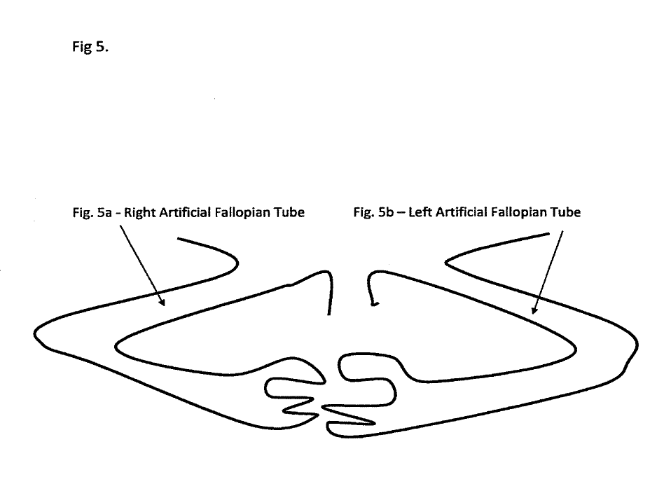

(I) Allaroundearth logo brand (E-JET & E-SPED) product Sales a (3G)pledge to a Green Global Goal Marketing Slogans allow distinguishable and recognizable branding for E-JET, & E-SPED, under umbrella Logo (Allaroundearth).” This Allaroundearth logo brand will allow pledges for a Global Environmental Agenda and create Green jobs. E-JET Green k-12 Curriculum leads to Green Job Trade Skill & Small Business upon Graduation. Green Job Training Copyright process with multi-industry Green Jobs & Small Business upon Certification of completion & On the Job Training Development. The Curriculum provides students with LEED GA, Green Training and small business skills to immediately start making an income, The Green Copyright Training invention provides an individual with a sixth grade learning level skills to obtain employment in a Green Job, Small Business and LEED GA Training, to take their skill sets and transfer them into income generating skills with or without contingency of employment from alternate outside factors and On the Job Training Development. (II) This invention will allow Outside Showering to be transportable to Construction Sites, Beaches and remote regions where potable water has limited accessibility. Green outdoor shower invention for portable use for contractors, beaches & remote regions without adequate water. (III) Wind turbine Protective Cover invention that protects birds. This Wind turbine Covering will allow standalone Wind turbines bird protection from the blades. (VI) Mobile Bike Folding Exercise Rack for Bikers and Marathon Riders (V) Mobile Folding Partition for traveling distance learning coaches and educators (VI) Synthetic-Polymer Fallopian Tube for patient pregnancy with tubal scar tissue.
Step 1: Allaroundearth (E-JET & E-SPED) Brand
Step 2: Green Global Goal, pledge card, with each product sales
Step 3: (E-JET) Green k-12 Curriculum
Step 4: Green k-12 Registration
Step 5: Green k-8 Curriculum
Step 6: Green 9-12 Grades Individual Needs & Goals Analysis
Step 7: Green 9-12 Grades Job and Workforce Development Training
Step 8: Green 9-12 Grades Personal, Professional Development Training
Step 9: Green 9-12 Grades Electives, LEED GA, Small Business Training
Step 10: Diploma, Graduation based upon State Standardize Testing
Step 11: Mentorship Program, Internship, College Referral Program
Step 12: (E-JET & E-SPED) Green Copyright Training
Step 13: Green Copyright Training Registration
   Green, Eco-Educational, Employment Entrepreneur Training, DVD's & Manual
   Copyright Registration Numbers:
      TXu-1-774-995 Effective date of Registration May 25, 2011
      TX 8-029-158 Effective date of Registration November 6, 2013
Step 14: Green Individual Needs & Goal Assessment
Step 15: Green Jobs and Workforce Development Training
Step 16: Green Personal, Professional Development Training
Step 17: Green LEED GA, Small Business Training
Step 18: Certification of Completion
Step 19: Mentorship Program
IR Step 20: Green Job, Internship, Temporary, Permanent & International Labor
Step 21: (E-SPED) Green Contracting, LEED GA Consultant, Network Marketing, Internet Marketing, Janitorial, Paint Recycling, Independent Contracting, Green Residential Rehabilitation (Automatic Lights and Plumbing Fixtures), Manufacturing Inventions(Nacelle/Wind Turbine Supply Chain), Internationally
Step 22: Green Outdoor Shower Invention
Step 23: Portable Plastic Outdoor Privacy Shelter
Step 24: Plastic Shower Head with expansion funnel water suction pump connected to water barrel
Step 25: Plastic Pedal pump connected to plastic funnel connection inside water Barrel, suction up water to Shower head in Portable Plastic outdoor Privacy Shelter
   a Legend: FIG. 1
      Green Outdoor Privacy Shelter
      Hole/Shower Extension
      Hole/Peddle Pump—(Privacy Shelter)
      Water Ventilation/Drainage+Cleaning
      Shower Head
      Nozzle Extension
      Peddle Pump
      Hole/Peddle Pump
      Water Barrel
      Hole/Peddle Pump (Water Barrel)
Step 26: Wind turbine Protective Cover Invention
Step 27: Large to Medium Size WIND TURBINES: Plastic or Steel ½′ to 1″ V-Shaped with Horizontal & Vertical, Square & Rectangular openings
Step 28: Connected to Each Blade based on Length×Width×Depth of Blades
Step 29: Plastic or Steel Clamp Connections to Each Blade
Step 30: Small WIND TURBINES: Plastic or Steel ½′ to 1″ V-Shaped with Horizontal & Vertical, Square & Rectangular openings.
Step 31: Connected together (Not to Blades) based on Length×Width×Depth of Blade
Step 32: Plastic or Steel Clamp Connections together to Each Wind Turbine Protective Covering.
   a Legend: FIG. 2
      Top-Protective Cover
      Bottom-Protective Cover
      Metal-Steelclamp
Step 33: Mobile Bicycle Exercise Rack—Parts:
   Unfold Mobile bike Rack, place wheel spokes upon Mobile Bike
   Legend: FIG. 3
      Mobile Bike Rack
      Handle Clamps
      Folding Side Clamps
      Exercise Strap Attachments
Step 34: Mobile Folding Partition—Parts:
   Unfold Mobile Partition, Set up for Phone Conferences and meetings.
   Legend: FIG. 4
      Plastic Mobile Partition
      Plastic Carrying Handles
      Folding Hinges
      Filing Slots
Step 35: Synthetic-Polymer Fallopian Tube—Parts:
   To be used in surgical procedures, artificial transplant or insemination
   Legend: FIG. 5
      1—Right Synthetic Artificial Fallopian Tube
      1—Left Synthetic Artificial Fallopian Tube
Step 36: E-JET SLOGAN: “Healthy Learning Healthy Living”, E-SPED. SLOGAN: “Eco-Savings is Our Business”
Step 37. MOBILE BIKE EXERCISE—FOLDING RACK for Bikers and Marathon Riders
   Step 35: Folding Hinges, Plastic or Metal Handles
Step 38. MOBILE FOLDING PARTITION for traveling distance learning coaches and educators
   Step 37: Folding; Hinges, Plastic or Metal Handles and pocket folders slots
Step 39. SYNTHETIC—POLYMER FALLOPIAN TUBE for patient pregnancy with tubal scar tissue.
   Step 39: Artificial or transplant, attach to Uterus and Ovaries

*Please Include SLOGANS:

E-JET, Inc—“Healthy Learning Healthy Living”

E-SPED, Inc—“Eco-Savings: is Our Business”(I) Allaroundearth logo brand for E-JET &. E-SPED (partnering organizations) & product Sales a (3G) pledge to a Green Global Goal. E-JET Slogan, “Healthy Learning =Healthy Living” E-SPED Slogan, “Eco-Savings is Our Business.” E-JET Green k-12 Curriculum leads to, job readiness, Green Job Trade Skill, LEED GA & Small Business Training upon Graduation, Green Job Training Copyright process (Curriculum use, also for On the Job Training) with multi-industry Green Jobs, Job Readiness, LEED GA & Small Business Training upon Certification of completion (II) Green outside shower invention for portable use for contractors, beaches & remote regions without adequate water (III) Wind turbine Cover invention that protects birds (VI) Mobile Bike Folding Exercise Rack for Bikers and Marathon Riders (V) Mobile Folding Partition for traveling distance learning coaches and educators (VI) Synthetic-Polymer Fallopian Tube for patient pregnancy with tubal scar tissue.

### BACKGROUND OF THE INVENTION

Problem Solved: (I) Current product logo brands do not have a Global Pledge that brings awareness to the environment, the Allaroundearth Green Global Goal pledge, marketing brand logo does. E-JET & E-SPED Slogans for recognizable to distinguish both organizational objectives and goals of each organization, under use of (Allaroundearth) umbrella marketing logo and brand. The k-12 education, often does not lead into Green Trade or Green Small Business with immediate opportunity for income, E-JET k-12 Green Curriculum does. In the Current rate of unemployment and layoffs and trainings that often leads to no jobs leads to further despair, The Green Copyright Curriculum leads to self-sufficiency skill development that offer the creation of Entrepreneurs, and job readiness for a Job market (II) Those who work as Contractors, go to the beach and those in remote regions all have the same issues, nowhere to wash off debris, sometimes chemicals, sand, and environmental hazards without bringing them in your automobiles, homes or affecting those around them, The Green Outdoor Shower allows for debris and hazardous materials to be washed with limited potable water and lower health risk (III) Small to medium size wind turbines offer hazards to the protection of our birds, this is a major barrier to entry into the market of manufacturing and job creations, The Wind Turbine Protective Cover, allows a protective shield for birds, lower barriers in the Alternative Energy Market and create jobs. (IV) Mobile Bike Folding Exercise Rack for Bikers and Marathon Riders (V) Mobile Folding Partition for traveling distance learning coaches and educators (VI) Synthetic-Polymer Fallopian Tube for patient pregnancy with tubal scar tissue and infertility concerns.

(I) Currently, marketing brands and logos that are limited to a particular business, and marketing pledges that raise awareness to an illness or particular product, not a Green Global Goal. Other business slogans do not allow distinguishing, recognizable objectives for both organizations E-JET, & E-SPED under umbrella marketing brand. Currently, k-12 Curriculum does not address the educational needs and skills in the Green Industry that leads students into employment or their own small business. Training programs offered requires individuals to learn a skill in other fields that may months or years to earn and income (II) The current outside showers require potable water, which limits access to showering. (III) The current Wind turbine coverings are for smaller compact wind turbine ventilators. (IV) Currently, there are no Mobile Bike Folding Exercise Rack for Bikers and Marathon Riders (V) Currently there are no Mobile Folding Partition for traveling distance learning coaches and educators (VI) Currently there are no Synthetic-Polymer Fallopian Tube for patient pregnancy with tubal scar tissue.

(I) This Allaroundearth brand logo will allow pledges for a Global Environmental Agenda and create Green jobs. Slogans will allow distinguishing, recognizable objectives for both organizations E-JET & E-SPED under umbrella marketing brand. E-JET Green k-12, Accredited Curriculum provides students with, Job readiness, LEED GA, Green Training and small business skills to immediately start making an income. The Green Copyright Training invention provides an individual with a sixth grade teaming level skills to obtain employment in a Green Job, Job readiness, Small Business and LEED GA Training, to take their skill sets and transfer them into income generating skills with or without contingency of employment from alternate outside factors, and On the Job Training skill Development (II) This invention will allow Outside Showering to be transportable to Construction Sites, Beaches and remote regions where potable water has limited accessibility (III) This Wind turbine Covering will allow standalone Wind turbines bird protection from the blades. (IV) Mobile Bike Folding Exercise Rack for Bikers and Marathon Riders (V) Mobile Folding Partition for traveling distance learning coaches and educators (VI) Synthetic-Polymer Fallopian Tube for patient pregnancy with tubal scar tissue.

### DETAILED DESCRIPTION OF THE INVENTION

As stated above, (I) Current product logo brands do not have a Global Pledge that brings awareness to the environment. Current, k-12 education, often do not lead into Green Trade or Green Small Business with immediate opportunity for income. Current Slogans offer no distinguishable, recognizable goals and objective, branding for E-JET c& E-SPED. In the Current rate of unemployment and layoffs and trainings that often leads to no jobs leads and further despair, with limited to no Green Copyright on the job training curriculum (II) Those who work as Contractors, go to the beach and those in remote regions all have the same issues, nowhere to wash off debris, sometimes chemicals, sand, and environmental hazards without bringing them in your automobiles, homes or affecting those around (III) Small to medium size wind turbines offer hazards to the protection of our birds, this is a major harrier to entry into the market of manufacturing and job. (IV) Due to raining and cold weather conditions Bike and Marathon Riders can exercise in hotels with Mobile Bike Exercise Folding Partition (V) Traveling, distance learning coaches and educators can train online in Hotel with Mobile Folding Partition (VI) Infertility patients with tubal scar tissue can have artificial Synthetic or Polymer Fallopian Tubes to increase safe and successful pregnancy for the baby.

The invention claimed here solves this problem:

1. (I) The Allaroundearth brand logo with the (3G—Green Global Goal) Pledge brings awareness to the Environment for a Global Initiative for a shared agenda. Current Slogans offer no distinguishable, recognizable goals and objective, branding for E-JET & E-SPED. The E-JET Green k-12 Curriculum will teach students job training, LEED GA, Green and or Small Business Trade to obtain income generation with less length of time. The Green Job Training Copyright Youth and Adult program allows individuals with a sixth grade education to prepare for the green jobs of today and healthy sustainable skill sets, Job readiness and LEED GA Training, that leads them to several Green jobs areas of employment for internships, temporary employment, permanent employment, the options to start their own Green Business, in addition to On the Job Training Curriculum (II) This Green outdoor Portable Shower will allow for those that work in Contracting, attend beaches and in remote regions to shower and wash off debris to lower health risk associated with the transfer of environmental concerns. (III) Wind turbine cover will lower the barriers of entry into the market, and protect. (IV) Due to raining and cold weather conditions Bike and Marathon Riders can exercise in hotels with Mobile Bike Exercise Folding Partition (V) Traveling, distance learning coaches and educators can train online in Hotel with Mobile Folding Partition (VI) Infertility patients with tubal scar tissue can have artificial Synthetic or Polymer Fallopian Tribes to increase safe and successful pregnancy for the baby. The claimed invention differs from what currently exists. (I) Other product logo brands are recognizable and used to market a particular business only without a shared Green Global Goal social agenda. Other, k-12 Curriculum does not lead into Green Trade or Small Business. Other Green Job Training Courses rely on other outside factors to provide jobs and employment this invention provides jobs and training based on individuals skill sets and goals as well as a transfer of skills into Green job and or Business opportunities within the training with Green Copyright Curriculum for On The Job Training E-JET & E-SPED established Recognizable, distinguishable, branding Slogans. (II) Other Green Outside showers use conventional water systems that require potable water this invention will require low to no potable water (III) Other wind turbines covers offer ventilators, this invention offers covering for standalone larger size wind turbine for manufacturing that lower barrier to entry into the market for job (IV) Currently, there are no Mobile Bike Folding Exercise Rack for Bikers and Marathon Riders (V) Currently there are no Mobile Folding Partition for traveling distance learning coaches and educators (VI) Currently there are no Synthetic-Polymer Fallopian Tube for patient pregnancy with tubal scar tissue. This invention is an improvement on what currently exists. (I) Other product logo brands are recognizable and used to market a particular business only without a shared social Global agenda. E-JET & E-SPED established Recognizable, distinguishable, branding Slogans. Other, k-12 Curriculum does not lead into Green Trade or Small Business. Other Job Training Courses rely on other outside factors to provide jobs and employment this invention provides jobs and training based on individuals skill sets and goals as well as a transfer of skills into Green job opportunities within the training and Green Copyright Curriculum used for On The Job Training (II) Other Green Outside showers use conventional water systems that require potable water this invention will require low to no potable water (III) Other wind turbines covers offer ventilators, this invention offers covering for standalone larger size wind turbine for manufacturing that lower barrier to entry into the market for job creation (VI) Currently, there are no Mobile Bike Folding Exercise Rack for Bikers and Marathon Riders (V) Currently there are no Mobile Folding Partition for traveling distance learning coaches and educators (VI) Currently there are no Synthetic-Polymer Fallopian Tube for patient pregnancy with tubal scar tissue. (I) Current product logo brands do not allow for pledges to the awareness to Global Green Goals pledge and Initiatives. Current Slogans offer no distinguishable, marketing objectives, for E-JET & E-SPED. Current, k-12 Curriculum offer trades in other industries, without the employment opportunities leads into Green internships, Temporary labor, permanent jobs, Green small businesses for students to immediately start making income with contractible, Green Copyright Curriculum to use for On The Job Training. Adult training programs offer longer lengths of time to earn an income through learning an additional trade, applying for employment with chances of experiencing additional layoffs with limited to no Green Copyright Curriculum for on the Job Training use. (II) Current outside showers has limited access and are often unsanitary, (III) The current wind turbine ventilators do not address the standalone wind turbines, their barrier to market entry due to the safety of birds. (IV) Currently, there are no Mobile Bike Folding Exercise Rack for Bikers and Marathon Riders (V) Currently there are no Mobile Folding Partition for traveling distance learning coaches and educators (VI) Currently there are no Synthetic-Polymer Fallopian Tube for patient pregnancy with tubal scar tissue. (I) This Allaroundearth logo brand will allow pledges for a Global Environmental Agenda and create Green job. Current Slogans offer no distinguishable, marketing objectives, for E-JET & &SPED. The Curriculum provides students with Job Readiness, LEED GA, Green Training and small business skills to immediately start making an income. The Green Copyright Training invention provides an individual with a sixth grade learning level skills to obtain employment in a Green Job, Small Business and LEED GA Training, to take their skill sets and transfer them into income generating skills with or without contingency of employment from alternate outside factors, the Curriculum also used for On The Job Training (II) This invention will allow Outside Showering to be transportable to Construction Sites, Beaches and remote regions where potable water has limited accessibility. (III) This Wind turbine Covering will allow standalone Wind turbines bird protection from the blades. (VI) Due to raining and cold weather conditions Bike and Marathon Riders can exercise in hotels with Mobile Bike Exercise Folding Partition (V) Traveling, distance learning coaches and educators can train online in Hotel with Mobile Folding Partition (VI) Infertility patients with tubal scar tissue can have artificial Synthetic or Polymer Fallopian Tubes to increase safe and successful pregnancy for the baby. Also, it can produce (I) Allaroundearth logo brand can produce T-Shirts, active wear, School and office products, in addition to marketing of additional products. Slogans produce, distinguishable, recognizable goals and objective, branding for E-JET & E-SPED.E-JET k-12 Curriculum and The Green Copyright Curriculum provide Students, individuals and employees, with Green Job readiness, LEED GA, Green Small Business and healthy life Style Skill Sets for Employment, Careers and Business opportunity for today's Green Market Job Industry. (II & III) Green Outdoor Shower (Plastic Shower Connection & Shelter) and Wind turbine Protective Covering are both products that can produce manufacturing products and jobs. (VI) Due to raining and cold weather conditions Bike and Marathon Riders can exercise in hotels with Mobile Bike Exercise Folding Partition (V) Traveling, distance learning coaches and educators can train online in Hotel with Mobile Folding Partition (VI) Infertility patients with tubal scar tissue can have artificial Synthetic or Polymer Fallopian Tubes to increase safe and successful pregnancy for the baby.
